(19) United States
(12) Patent Application Publication
(10) Pub. No.: US 2022/0001472 A1
(43) Pub. Date: Jan. 6, 2022

(54) METHOD FOR REMOVING A SUPPORT STRUCTURE AND TOOL THEREFOR

(71) Applicant: Extrude Hone GmbH, Holzguenz (DE)

(72) Inventors: Frank WEINGAERTNER, Holzguenz (DE); Fabio Augusto WOSNIAK, Holzguenz (DE); Patrick MATT, Holzguenz (DE); Mariana CABRERA, Holzguenz (DE)

(21) Appl. No.: 17/290,717

(22) PCT Filed: Oct. 30, 2019
(86) PCT No.: PCT/EP2019/079684

§ 371 Date: Apr. 30, 2021

(30) Foreign Application Priority Data
Oct. 30, 2018 (DE) 10 2018 127 023.2

(51) Int. Cl. B23D 79/00; B22F 10/20; B22F 10/40

(52) U.S. Cl. CPC B23D 79/005; B22F 10/20; B33Y 80/00; B22F 2998/10; B22F 2999/00; B22F 10/40

(57) ABSTRACT

A method for removing a support structure in a component produced by additive manufacturing provides that explosive gas introduced into a pressure chamber is ignited, wherein a gas conveying device with which the flame front is guided into the cavity is also additionally provided in the chamber. A tool for carrying out the method is also indicated.

The invention relates to a method for removing a support structure in a cavity of a component made of metal and produced by means of additive manufacturing.

By means of additive manufacturing, components can now be produced which have cavities inside them, which could not previously be produced. Additive manufacturing methods are usually characterized by a layer-by-layer construction.

The invention relates to a method in which a support structure in a cavity of a metallic component produced by means of any additive manufacturing method can be easily removed. Such support structures are also manufactured when the component is produced, in order to achieve a sufficient stability of the not yet complete walls during the manufacturing process. Such support structures can be envisaged in a simplified manner as columns which support the wall of a cavity.

In the state of the art there are considerations as to how such support structures can be removed, as they are not to restrict the cavity, but only to function as a temporary support structure. This means that the finished component no longer has these support structures.

The term “support structure” in the following also includes several physical connecting structures separate from each other, in particular even all the support structures present in the cavity, which are to be removed.

From DE 10 2016 115 674 A1 a method for removing a support structure is known, in which the support structure is first destroyed by a sudden thermal pulse at the transition to the adjacent wall. The remainder of the support structure is then mechanically removed.

U.S. Pat. No. 9,808,865 B2 likewise discloses a method for removing a support structure, which operates with a gas-filled chamber in which the component is in turn accommodated. The chamber is filled with a gas mixture. In the process, the cavity is also filled with this gas mixture, with the result that by igniting the gas mixture in the cavity a flame is produced, which combusts the support structure. In the case of larger support structures, several operations are carried out, i.e. the chamber is filled and the gas mixture ignited several times, in order to completely remove the support structures.

The object of the invention is to provide a method for removing support structures, with which relatively large volumes of support structure can be removed, and, in addition, more support structure material can be removed with the same quantity of energy to be found in the chamber.

This is achieved by the method according to the invention, including the steps of:

introducing the component into a pressure chamber bordered by walls,

positioning at least one gas conveying device in front of at least one opening in the component, leading into the cavity,

filling the pressure chamber and the cavity with an explosive gas and oxygen, with an excess of oxygen, and

igniting the gas in the pressure chamber and vaporizing the support structure in the cavity by means of the combusting gas.

The gas conveying device which is additionally introduced into the pressure chamber (as an extra part) provides for an increased gas flow to/from the cavity and thus within the cavity, which has a positive effect on the vaporization process in the cavity. As a result, more energy is in fact utilized in the cavity in order to vaporize the support structures. Furthermore, the velocity of the hot gas and the flame front in the cavity is greater than previously, which substantially improves the removal of the support structure. Thus, in the same chamber, which can be exposed to a limited charging pressure, a component can be processed, in which a larger mass of support structure is removed than was previously possible. Thus, larger components and more support structure volume can be processed without the so-called charging pressure being increased.

In the method according to the invention, an explosive gas mixture is ignited via an external energy source. The process takes place adiabatically, i.e. as the volume is constant through the chamber volume, a sudden increase in pressure and temperature takes place in the chamber depending on the energy content of the gas, the loading pressure of the gases and the selected ratio of gas to oxygen in the mixture, with an excess of oxygen. The reaction proceeds exothermically.

The method according to the invention provides a sufficient quantity of energy to heat the support structures to be removed to melting temperature and to vaporization temperature, wherein the excess of oxygen present makes possible not only the combustion of the gas, but furthermore an oxidation of the support structures to be removed.

The support structures to be removed are usually always formed such that a heat accumulation can form on the support structures in the cavity, i.e. the surface is large enough to absorb a large amount of energy from the environment. Furthermore, the volume of the support structure should be small enough to achieve the heat accumulation and dissipate as little energy as possible, and to bring the material to a sufficient temperature for the vaporization. The high velocity with which the flame front is moved through the cavity prevents the formation of so-called welding beads, which could at least partly clog the cavity, and which would furthermore prevent the removal of material.

The invention bypasses the disadvantage of previous methods in which the maximum permissible charging pressure decreases as the size of a pressure chamber increases, and thus less energy is available inside through the gas mixture, in order to vaporize material.

The method according to the invention optionally provides that an opening (i.e. the singular opening or one of several openings), in front of which the gas conveying device is positioned, is an inlet opening into the cavity for a flame front produced when the gas is ignited. This means that the gas conveying device directs the flame front into the cavity via the inlet opening in a targeted manner. The ignition of the explosive gas usually takes place at the edge of the pressure chamber via an ignition device, for example by means of an ignition plug which is attached to a mixing block which is attached to the side of the pressure chamber. Previously the flame front was able to propagate inside the pressure chamber in an undirected manner. This means that a large part of the flame front and associated energy took effect outside the component, rather than within the cavity.

With the method according to the invention, all of the support structures in the cavity are preferably vaporized by means of a single ignition and filling with gas.

If two ignitions are needed, it is likewise possible to operate with an excess of oxygen when the second filling with gas takes place. In previous methods, the subsequent iterations were always carried out with stoichiometric ratios.

In this case, a nozzle positioned in front of the inlet opening can be used as the gas conveying device; the nozzle is optionally spaced apart from the inlet opening by a gap. The nozzle directs and concentrates the flame front towards the inlet opening and thus into the cavity. A part of the flame front which previously (without the gas conveying device) struck the component on the outside is thus guided into the cavity.

The gap between the nozzle and the inlet opening does not need to be present; the nozzle preferably adjoins the inlet opening in a gastight manner. If a gap is present, it is preferably a maximum of 50 mm, in particular a maximum of 10 mm in size, measured in the flow direction.

Furthermore, a duct which has a first end open towards an ignition device and a second end open towards the inlet opening can be used as the gas conveying device, wherein via the first end a flame front forming on ignition of the gas is guided into the duct and out of the second end.

The duct is usually formed by a tool part, for example a kind of tube. The purpose of this duct is that the quantity of explosive gas which is in the duct is almost completely, or in fact completely, available as energy which is guided into the cavity. On combustion, this part of all of the gas in the pressure chamber is consequently available as energy for vaporizing the support structure and does not “deflagrate” outside the component.

A gap is optionally present between the duct and the introduction opening for gas, wherein this gap should be a maximum of 100 mm, preferably a maximum of 50 mm and ideally a maximum of 10 mm in size, measured in the longitudinal direction of the channel. Another variant of the invention provides that the channel begins directly at the introduction opening, i.e. the channel wall adjoins the wall of the pressure chamber directly and in a gastight manner in this area.

The introduction opening is provided in particular on the upper wall, i.e. on the ceiling of the pressure chamber, and the channel runs vertically.

A variant of the invention provides that the aforesaid nozzle is positioned between the duct and the associated inlet opening. The duct has a first end, open towards an ignition device. The second end of the duct is directed towards the nozzle. The flame front is guided via the duct into the nozzle and from there via the inlet opening into the cavity. This has the advantage that the duct can be larger in cross section than the nozzle outlet, and thus a larger gas volume is available for vaporizing the support structure. In addition, the flame front is accelerated in the nozzle and enters the cavity at a greater velocity, which has a positive effect on the vaporization process.

The volume of the duct and the gas pressure, as well as the type of gas are matched to the support structure(s) such that the energy produced on combustion of the gas in the chamber is sufficient to vaporize the entire support structure. Consequently, it is mathematically determined in advance how large the duct has to be in order to be able to vaporize the volume and thus the mass of the support structure, namely with a singular loading process and ignition process in the pressure chamber. Due to the fact that the volume of the cavity is not included in the calculation, an additional buffer is provided with respect to the energy which is ultimately made available in the cavity on ignition.

The area between the duct and the nozzle should in particular be designed gastight; in other words, the duct rests on the nozzle. Alternatively, a gap can be present for this purpose between the duct and the nozzle, which is a maximum of 100 mm, preferably a maximum of 50 mm and ideally a maximum of 10 mm in size, measured in the flow direction.

If no nozzle is provided, the duct can also be directed directly onto the opening in the component, and in this case can adjoin the opening either directly and in a gastight manner or with the interposition of a gap which is to be preferably a maximum of 50 mm, in particular a maximum of 20 mm and ideally a maximum of 5 mm in size, measured in the flow direction.

In addition, the cavity can have an opening which is an outlet opening for the flame front produced on ignition of the gas, wherein a gas conveying device in the form of a deflecting wall is provided in front of the outlet opening, forming a gap, and the flame front propagates via the gap into the remainder of the pressure chamber. This variant is optionally usable as a gas conveying device in addition to the nozzle and duct, or in addition to one or both of these gas conveying devices. The deflecting wall is a separate tool part, which is introduced into the pressure chamber and thus does not form the wall of the pressure chamber. It has been found that the pressure in the cavity is increased by the deflecting wall, with the result that there is a higher differential pressure between the cavity and the outer area of the pressure chamber. This leads to a higher velocity of the flame front inside the cavity and also to a longer action time of the flames in the cavity, which in turn has a positive effect on the vaporization process. The aforesaid gap can preferably be between 0.5 and 5 mm in size, measured in the flow direction.

In this embodiment, the quantity of gas in the pressure chamber is selected such that the entire support structure is vaporized with one ignition. If the above-mentioned duct is also used in addition to the deflecting wall, the quantity of gas in the duct must be sufficient to vaporize the support structure with one ignition.

According to one embodiment, the inside of the pressure chamber including the component is heated before ignition, preferably to a temperature in the range of from 40 to 60° C., further preferably to a temperature in the range of from 40 to 50° C. This quantity of energy which at first sight appears small, and which is fed through a heating device, still has a very positive effect on the processing operation, as tests have shown.

In addition, the invention relates to a tool for carrying out the method according to the invention, comprising a pressure chamber, an introduction opening for pressurized gas on the chamber side, an ignition device and a gas conveying device, which can be positioned in front of an opening to a cavity of an additively manufactured tool to be processed.

As already mentioned above, according to a variant of the invention, the gas conveying device is a nozzle.

An additional or optionally different gas conveying device is the above-mentioned duct attached inside the pressure chamber, with an open, first end facing the ignition device and an opposite, open, second end directed towards the opening of the component.

The second end can be positioned on the input side of the nozzle.

In addition, it is provided that the tool is equipped with a gas conveying device in the form of a deflecting wall which can be positioned in front of an outlet opening of the cavity in the component.

The nozzle, the duct and/or the deflecting wall can be secured in a holder or on a holder in the pressure chamber. The holder is preferably a shared holder, which optionally also serves as holder for the component itself.

The duct is preferably designed as a tube. The tube can be a linear tube.

Methane or hydrogen, for example, are used as gas.

The reaction when the gas is ignited preferably takes place adiabatically.

The process can take place either with stoichiometric combustion or combustion with an excess of oxygen. The higher the oxygen content, the lower the resultant combustion temperature, but the more iron can be oxidized.

The filling pressure is between 3 and 50 bar when hydrogen is used, and 0.5 to 23 bar in the case of methane, depending on the material of the component.

The following further measures for improving the efficiency of the method and tool according to the invention are possible, also in combination with the features above and below:

a) duct:
reducing the duct diameter from large to small, i.e. the duct itself becomes a part of the nozzle or a kind of upstream nozzle;
polishing the inside of the duct to minimize friction losses;
chamfering the inlet edges at changes in diameter;
duct/tube as a Venturi tube or as a Laval tube; and/or
deflector plates in the channel for flow deflection

b) nozzle:
incorporating a diffusor into the gas conveying device;
nozzle integrated into duct, either converging or with a Laval design, or designed as a Venturi nozzle;
introducing a core into the duct in order to bring about changes in diameter;
core forms Laval nozzle

c) turbine wheel;
introducing a motor-driven turbine wheel into the duct to enhance the flow.

Further features and advantages of the invention will become clear from the following description and from the following drawings, to which reference is made and in which:

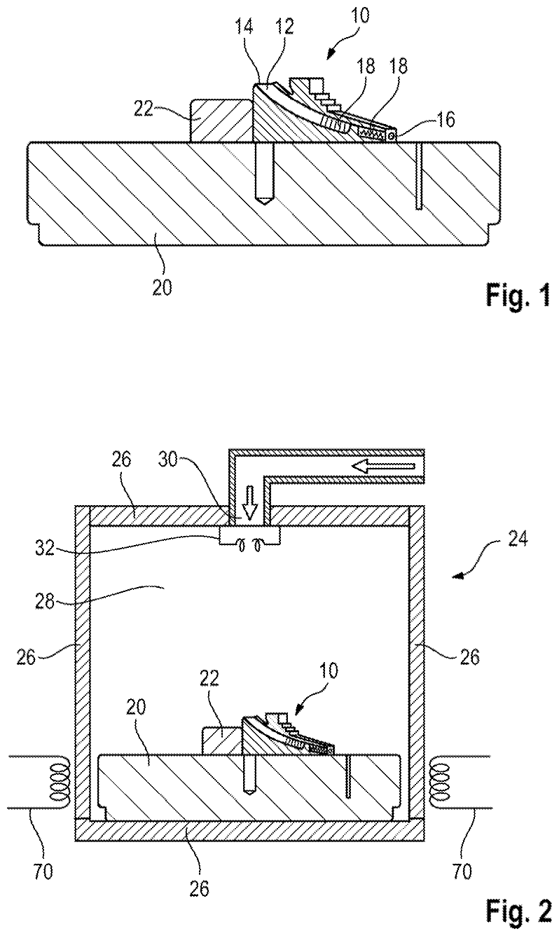

FIG. 1 shows an enlarged, schematic view of a component to be processed,

FIG. 2 shows the component according to FIG. 1 inserted into the tool according to the invention, the tool not yet having a gas conveying device mounted therein,

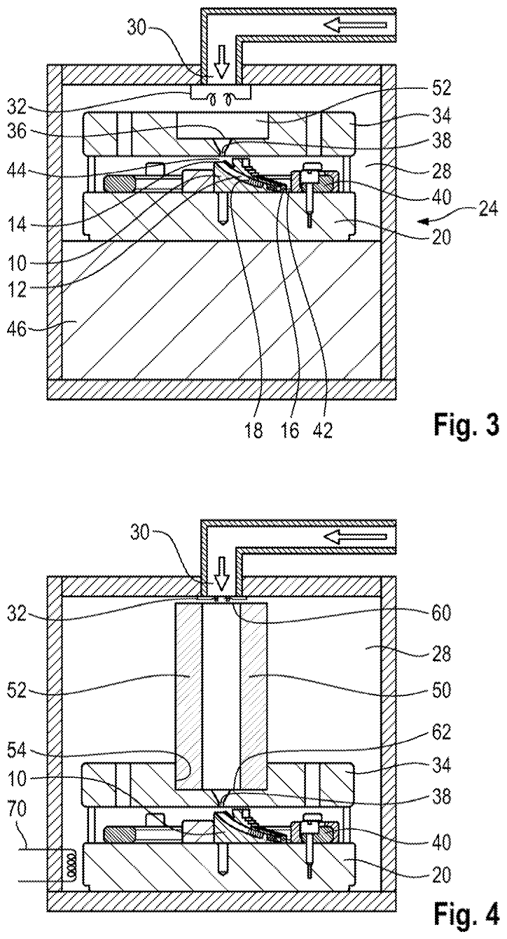

FIG. 3 shows the tool according to FIG. 2, in which two gas conveying devices are introduced, for carrying out the method according to the invention, and

FIG. 4 shows the tool according to the invention, in which another gas conveying device is introduced, for carrying out the method according to the invention.

FIG. 1 shows a component 10 produced by additive manufacturing, for example a so-called impeller segment.

The component, which is made from metal, is produced for example by laser sintering.

In the component, one or more cavities 12 are formed, which in this case have two opposite ends with which the cavity 12 passes into the open, namely an open, first end 14 and an opposite, open, second end 16.

In the cavity 12, one or more so-called support structures 18 are formed, i.e. during production, to put it simply, columns are also produced, which temporarily couple opposing wall sections bordering the cavity 12 to one another, in order to ensure the stability of the component 10 during the production process.

FIG. 1 also shows a holder 20 as well as a positioning block 22, with which the component 10 is introduced into a tool 24 shown in FIG. 2 and is positioned there.

The tool 24 comprises a pressure chamber 28 bordered by walls 26, which accommodates the holder 20 and component 10. Usually, either a side wall or a ceiling wall can be removed, in order to make possible a quick component change.

The component 10 is preferably secured to the holder 20 outside the tool 24 and detached from it again.

The tool 24 comprises an introduction opening 30 for inflammable pressurized gas, for example methane or hydrogen, and an electric ignition device 32 provided in front of the introduction opening 30, in particular in the pressure chamber 28, for igniting the pressurized gas.

FIG. 3 shows the tool 24 according to FIG. 2, which is however provided with two gas conveying devices, in order to achieve a higher processing efficiency, i.e. in order to be able to vaporize more support structure during a loading and igniting process.

The cavity 12 is open towards the outside, namely preferably via two openings, namely a so-called inlet opening 14 and an outlet opening 16, which is located at the opposite end of the cavity 12. In addition, however, several inlet openings 14 and/or outlet openings 16 can also be provided.

A gas conveying device in the form of a nozzle 34 is provided in front of the inlet opening 14, wherein the nozzle 34 has an inlet cross section 36 as well as a significantly smaller outlet cross section 38, which is directed towards the inlet opening 14 and aligned therewith.

Above the inlet cross section 36, the component forming the nozzle has a cylindrical portion, which can also be omitted. This cylindrical portion forms an axially short channel 52 which passes into the nozzle 34.

The component 10 with the inlet opening 14 is preferably oriented towards the introduction opening 30; in the present case these openings lie one below the other.

The nozzle 34 can, optionally, be connected to the holder 20.

In addition, a second gas conveying device is provided, in the form of a deflector plate 40, which is placed in front of the outlet opening 16, namely at a certain distance, forming a gap 42, which is preferably between 0.5 mm and 5 mm in size, measured in the flow direction.

A gap 44, albeit small, is also present between the nozzle 34 and the inlet opening 14.

In order to bring the nozzle 34 and the component 10 as close as possible to the introduction opening 30, a base part 46 introduced into the pressure chamber 28 is provided, which fills a lower part of the pressure chamber 28.

The nozzle 34 and the deflector plate 40 can of course initially be positioned outside the pressure chamber 28, relative to the component 10, and for example already be connected to the holder 20 there, with the result that the unit then produced is jointly introduced into the pressure chamber 28 and positioned therein.

This also applies to the embodiment explained below.

This embodiment differs from that according to FIG. 4 in that the base part 46 is not present and in that a further gas conveying device, in the form of a duct 52 formed by a tube 50 and realized therein, is provided.

The duct 52 is positioned on the nozzle 34, which optionally has a corresponding opening 54 for inserting the tube 50, in order to enable, so far as possible, a gastight closure between the tube 50 and the nozzle 34.

The internal cross section of the duct 52 is, in particular, constant and larger than the outlet cross section 38 of the nozzle 34.

The duct 52 has an open, first end 60 which is open towards the ignition device 32 and thus also points towards the introduction opening 30.

The opposite, open, second end 62 then points towards the nozzle 34, here even towards the outlet cross section 38 of the nozzle 34.

In general, the introduction opening 30 need not directly face the nozzle 34 or the duct 52; it is even more important that the nozzle 34 and, if present, the duct 52 face the ignition device 32, because the flame front produced later emanates from the ignition device 32.

Furthermore, a heating device 70, only represented in FIG. 2 for the sake of simplification, is provided, which, before the ignition, explained below, of a pressurized gas guided into the pressure chamber 28, heats up the pressurized gas and the component 10 to a temperature of 40 to 60° C., in particular 40 to 50° C.

The method for removing the support structure 18 (or, better, all the support structures 18) in the cavity 12 is explained below.

After the introduction of the component 10 into the pressure chamber 28, and the prior or subsequent positioning of one or more of the aforesaid gas conveying devices in front of an opening leading into the cavity 12, i.e. here the inlet opening 14 and the outlet opening 16, the pressure chamber 28 is filled with explosive gas which, because of the open cavity 12, also fills the cavity 12 itself.

The gas is ignited by the ignition device 32, and the flame front forming will penetrate directly into the nozzle 34 according to FIG. 3, be concentrated there and at an increased velocity penetrate via the gap 44 into the inlet opening 14 and the cavity 12, where it leads to the direct vaporization of all the support structures 18. The flame front exits the cavity 12 via the outlet opening 16 and, after bridging the gap 42, reaches the deflector plate 40, which leads to a build-up of pressure in the cavity 12, with the result that there is a strong pressure difference between the cavity 12 and the remainder of the pressure chamber 28, which in turn leads on the one hand to a longer residence time of the flame front in the cavity 12 and on the other hand to a higher velocity of the flame front.

The entire quantity of gas in the pressure chamber 28 is selected such that all the support structures 18 are vaporized with one ignition, i.e. with one gas charge.

In the embodiment according to FIG. 4, the gas pressure, the type of gas and the volume of the duct 52 are matched to one another such that the gas contained in the duct 52 is sufficient to vaporize the entirety of the support structures 18 in one ignition process, i.e. in one filling process.

The resultant flame front in the duct 52 shoots into the nozzle 34, is in turn concentrated there in order to get into the cavity 12 at a high velocity, and to leave it again via the outlet opening 16.

It is to be stressed that each of the three gas conveying devices mentioned is suitable by itself to achieve an improved vaporization of the support structures 18.

Because a quantity of gas inside the pressure chamber 28 is now separated for the cavity 12 via the nozzle 34 and the duct 52, more support structure 18 can be vaporized with a smaller effective volume in the pressure chamber 28 than previously. This means that, overall, less gas or a lower gas pressure need to be present. It is thus also possible to use larger pressure chambers 28, which have a lower operating pressure than smaller, compact pressure chambers 28.

It is to be stressed that optionally no gap has to be present between the nozzle 34 and the component, but that the nozzle 34 can also directly adjoin the component and rest against it.

Furthermore, a small gap of a maximum of 100 mm, in particular a maximum of 50 mm, ideally a maximum of 10 mm can optionally be present between the tube 50 and the nozzle 34.

Finally, the tube 50 can also directly adjoin the upper wall 26 of the pressure chamber 28.

Of course, a processing, in which e.g. burrs are removed, will also take place on the outside of the component or of a so-called support of the component due to the explosion.

The features described and shown in the Figures are not restricted to the use only in combination with all the features described and shown in the respective Figures Rather, these features separately already ensure advantages and can be used alone in isolation from the other features or in other combinations of features and here lead to advantages. Also, combinations of features are not restricted to these combinations by use in the same sentence or paragraph.

1-18. (canceled)

19. A method for removing a support structure in a cavity of a component of metal and produced by an additive manufacturing, comprising the steps of:
introducing the component into a pressure chamber bordered by walls,
positioning at least one gas conveying device in front of at least one opening in the component, which opening leads into the cavity,
filling the pressure chamber and the cavity with an explosive gas and with oxygen, with an excess of oxygen, and
igniting the gas in the pressure chamber and vaporizing the support structure in the cavity by the combusting gas.

20. The method according to claim 19, wherein an opening is an inlet opening for a flame front produced on ignition of the gas.

21. The method according to claim 20, wherein the gas conveying device is a nozzle positioned in front of the inlet opening, in particular wherein the nozzle is spaced apart from the inlet opening by a gap.

22. The method according to claim 19, wherein a duct which has a first end open towards an ignition device and a second end open towards the inlet opening is used as the gas conveying device, wherein via the first end a flame front forming on ignition of the gas is guided into the duct or is produced there and guided out of the second end.

23. The method according to claim 22, wherein the volume in the duct and the gas pressure, as well as the type of gas are matched to the support structures such that the energy produced on combustion of the gas in the duct is sufficient to vaporize the entire support structure.

24. The method according to claim 21, wherein the nozzle is located between the duct and the associated inlet opening, and the second end of the duct is directed towards the nozzle, and the flame front is guided via the duct into the nozzle and from there via the inlet opening into the cavity.

25. The method according to claim 22, wherein the nozzle is located between the duct and the associated inlet opening, and the second end of the duct is directed towards the nozzle, and the flame front is guided via the duct into the nozzle and from there via the inlet opening into the cavity.

26. The method according to claim 23, wherein the nozzle is located between the duct and the associated inlet opening, and the second end of the duct is directed towards the nozzle, and the flame front is guided via the duct into the nozzle and from there via the inlet opening into the cavity.

27. The method according to claim 24, wherein the area between the duct and the nozzle is gastight.

28. The method according to claim 19, wherein the cavity has an opening which is an outlet opening for the flame front produced on ignition of the gas, wherein a gas conveying device in the form of a deflecting wall is provided in front of the outlet opening, forming a gap in particular between 0.5 and 5 mm in size, wherein the flame front can propagate via the gap into the remainder of the pressure chamber.

29. The method according to claim 19, wherein the quantity of gas in the pressure chamber is selected such that the entirety of the support structures are vaporized with one ignition.

30. The method according to claim 19, wherein the inside of the pressure chamber, including the component, is heated before the ignition of the gas takes place, preferably to a temperature in the range of from 40 to 60° C., in particular in the range of from 40 to 50° C.

31. A tool for carrying out the method according to claim 19, comprising a pressure chamber, an introduction opening for pressurized gas on the chamber side, an ignition device and at least one gas conveying device, which can be positioned in front of an opening to a cavity of an additively manufactured component to be processed.

32. The tool according to claim 31, wherein a gas conveying device in the form of a nozzle is provided, in particular wherein a gap between the nozzle and the opening in the component is a maximum of 100 mm, in particular a maximum of 50 mm, further in particular a maximum of 10 mm, or the nozzle rests on the opening.

33. The tool according claim 31, wherein the gas conveying device is a duct attached inside the pressure chamber, with an open, first end facing the ignition device and an opposite, open, second end directed towards the opening of the component.

34. The tool according to claim 33, wherein between the duct and the introduction opening there is no distance or there is a maximum distance of 100 mm, in particular a maximum of 50 mm, further in particular a maximum of 10 mm.

35. The tool according to claim 31, wherein the second end of the duct is positioned on the input side of the nozzle.

36. The tool according to claim 31, wherein the introduction opening is provided centrally and on an upper wall of the pressure chamber, and in that the duct runs vertically.

37. The tool according to claim 31, wherein a gas conveying device is a deflecting wall configured to be positioned in front of an outlet opening of the cavity.

38. The tool according to claim 31, wherein the deflecting wall has a gap to the outlet opening, which is between 0.5 and 5 mm in size, measured in the flow direction.
